(19) United States
(12) Patent Application Publication
(10) Pub. No.: US 2016/0227222 A1
(43) Pub. Date: Aug. 4, 2016

(54) Multi-Standard Video Decoder with Novel Intra Prediction Decoding

(71) Applicant: MediaTek Inc., Hsin-Chu (TW)

(72) Inventors: Meng Jye HU, Taoyuan City (TW); Chia-Yun CHENG, Zhubei City (TW); Yung-Chang CHANG, New Taipei City (TW)

(21) Appl. No.: 14/993,394

(22) Filed: Jan. 12, 2016

Related U.S. Application Data
(60) Provisional application No. 62/110,680, filed on Feb. 2, 2015.

(51) Int. Cl. H04N 19/159; H04N 19/436; H04N 19/176; H04N 19/117; H04N 19/593; H04N 19/105

(52) U.S. Cl. CPC H04N 19/159; H04N 19/593; H04N 19/105; H04N 19/176; H04N 19/117; H04N 19/436

(57) ABSTRACT

An apparatus for multi-standard Intra prediction decoding in a video decoder for decoding two video streams coded in two different video coding standards is disclosed. The apparatus comprises a first Intra prediction decoder to decode a first bitstream comprising one or more first Intra prediction coded blocks, and a second Intra prediction decoder to decode a second bitstream comprising one or more second Intra prediction coded blocks. The first Intra prediction coded blocks are coded according to a first video coding standard and the second Intra prediction coded blocks are coded according to a second video coding standard. The first Intra prediction decoder and the second Intra prediction decoder are arranged to perform Intra prediction decoding on the two video streams simultaneously by decoding the two video streams in an interleaved manner at a picture level, slice level, or largest coding unit (LCU)/macroblock (MB) level.

### CROSS REFERENCE TO RELATED APPLICATIONS

The present invention claims priority to U.S. Provisional Patent Application, Ser. No. 62/110,680, filed on Feb. 2, 2015. The U.S. Provisional Patent Application is hereby incorporated by reference in its entirety.

### FIELD OF THE INVENTION

The present invention relates to multi-standard video decoding system. In particular, the present invention relates to area-efficient or high performance Intra prediction decoding design to support different Intra prediction decoders as required by different video coding standards.

### BACKGROUND

Video data requires a lot of storage space to store or a wide bandwidth to transmit. Along with the growing high resolution and higher frame rates, the storage or transmission bandwidth requirements would be formidable if the video data is stored or transmitted in an uncompressed form. Therefore, video data is often stored or transmitted in a compressed format using video coding techniques. The coding efficiency has been substantially improved using newer video coding standard such as H.264/AVC and the emerging HEVC (High Efficiency Video Coding) standard. In order to maintain manageable complexity, an image is often divided into blocks, such as macroblock (MB) or LCU/CU to apply video coding. Video coding standards usually adopt adaptive Inter/Intra prediction on a block basis.

FIG. 1 illustrates an exemplary system block diagram for video decoder 100 to support HEVC video standard. High-Efficiency Video Coding (HEVC) is a new international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block. A CU may begin with a largest CU (LCU), which is also referred as coded tree unit (CTU) in HEVC and each CU can be recursively split into four smaller CUs until the predefined minimum size is reached. Once the splitting of CU hierarchical tree is done, each CU is further split into one or more prediction units (PUs) according to prediction type and PU partition. Each CU or the residual of each CU is divided into a tree of transform units (TUs) to apply two-dimensional (2D) transforms

In FIG. 1, the input video bitstream is first processed by variable length decoder (VLD) using entropy decoding engine 110 to perform variable-length decoding and syntax parsing. The parsed syntax may correspond to Inter/Intra residue signal (the upper output path from entropy decoding engine 110) or motion information (the lower output path from entropy decoding engine 110). The residue signal usually is transform coded. Accordingly, the coded residue signal is processed by inverse scan (IS)/inverse quantization (IQ) block 112, and inverse transform (IT) block 114. The output from inverse transform (IT) block 114 corresponds to reconstructed residual signal. The reconstructed residual signal is added to reconstruction block 116 along with Intra prediction from Intra prediction block 118 for an Intra-coded block or Inter prediction from motion compensation block 120 for an Inter-coded block through Inter/Intra selection block 122. Inter/Intra selection block 122 selects Intra prediction or Inter prediction for reconstructing the video signal depending on whether the block is Inter or Intra coded. For motion compensation, the process will access one or more reference blocks stored in decoded picture buffer 124 and motion vector information determined by motion vector (MV) generation block 126. In order to improve visual quality, deblocking filter 128 and Sample Adaptive Offset (SAO) filter (130) are used to process reconstructed video before it is stored in the decoded picture buffer 124. For the H.264/AVC standard, only the deblocking filter (DF) is used without the sample adaptive offset (SAO) filter.

Other than the H.264/AVC and HEVC video coding standards, there are also other formats being used such as Window media Video (WMV) and VP8/VP9. On the other hand, AVS video coding is a video coding standard developed by China and the format is widely used in China. The video coding tool set used for AVS is similar to that for H.264/AVC. However, the complexity of AVS is greatly reduced compared to the H.264/AVC standard. Nevertheless, the coding performance of AVS is comparable to that of H.264/AVC.

Due to the co-existing of compressed video in various video coding formats, a video decoder may have to decoder various video formats in order to allow a user to watch video contents coded in different video coding formats. Furthermore, there may be a need for simultaneously decoding two compressed video data coded in different video coding formats. For example, a user may be watching two video sequences displayed on a TV screen in a main/sub-picture or split screen arrangement, where one sequence is coded in one video coding format while the other sequence is coded in a different format.

FIG. 2 illustrates a typical TV system with built-in audio/video decoder. As shown in FIG. 2, the system uses a CPU bus and DRAM (dynamic random access memory) bus. The external memory storage (210) is used to store reference pictures for video decoding, decoded pictures for display and other data. The external memory often uses DRAM (dynamic random access memory) and external memory access engine (220) is used to connect the external memory storage to the data bus. The system may include a CPU (230), a video decoder (240), an audio engine (250) and a display engine (260). The video decoder will perform the task of video decoding for compressed video data. The audio engine will perform the task of audio decoding for compressed audio data. The audio engine may also support other audio tasks such as generating audio prompt for user interface. The display engine is responsible for processing video display and generating display information. For example, the display engine may generate graphic or text information for user interface. The display engine is also responsible for combining two decoded video data for main window and sub-window display, or split screen display. The CPU may be used to initialize the system, control other sub-systems, or provide user interface for the TV system.

In order to support simultaneous multi-standard video decoding and display, the video decoding system may be configured to decode one coded video data and then switch to decode another coded video data. For example, if the video decoder system needs to simultaneously decode a first video bitstream coded in the HEVC format and a second video bitstream coded in the AVS format, the decoder system may decode one HEVC picture and switch to decode an AVS picture. The decoded HEVC pictures and AVS pictures can be temporarily stored in output picture buffer. The display engine may access the pictures for picture in picture display or split screen display.

In video coding, the Intra prediction mode is often used for scene changes since Inter prediction often fails to render reasonable prediction. Intra prediction is also used periodically in a video sequence to alleviate the error propagation issue.

For Intra prediction decoding according to HEVC, the decoded boundary samples of adjacent blocks are used as reference data for spatial prediction of a current block. All TUs within a PU use the same associated Intra prediction mode for the luma component and the chroma components. The encoder selects the best luma Intra prediction mode of each PU from 35 options corresponding to 33 directional prediction modes, a DC mode and a Planar mode. The 33 possible Intra prediction directions are illustrated in FIG. 4, where Planar mode is mapped to Intra prediction mode number 0 while DC mode is mapped to Intra prediction mode number 1. In HEVC, the LCU can be set to 64×64, 32×32 or 16×16. Depending on the CU size, the largest PU size for a given CU size can be 64×64, 32×32, 16×16 or 8×8. For each CU, the residual is derived after Inter or Intra prediction is applied to PUs within the CU. The residual within a CU is then divided into TUs according to residual quadtree partition. The allowed TU sizes are 32×32, 16×16, 8×8 and 4×4.

For Intra prediction, the predictors for samples in the current block (i.e., TU) is derived using the reconstructed neighboring samples above the top block boundary and the reconstructed neighboring samples adjacent to the left block boundary. Since various angular Intra predictions are supported, the reconstructed neighboring samples above the top block boundary may be extended to above the top block boundary of the right block, or adjacent to the left block boundary of the below block. The reconstructed neighboring samples may be pre-processed by a FIR filter with weighting factors corresponding to (¼, ½, ¼) before they are used to derive the predictors for the current block. This FIR filter is referred as pre-filter or neighbor pre-filter. Whether this smoothing operation is used depends on the TU size and the Intra prediction mode. The predictors for the current block are then derived according to the selected Intra prediction mode. After the initial Intra prediction samples are generated, Intra gradient filter or Intra prediction smoothing filter is further applied to the initial Intra prediction samples at the left column and top row within the current TU when the Intra prediction mode is DC, horizontal, or vertical mode. The HEVC standard also supports constrained Intra prediction, where if reconstructed neighboring samples are Inter coded, these reconstructed neighboring samples are considered as unavailable. The constrained Intra prediction can help to alleviate error propagation due to the use of Inter-coded samples to derive Intra predictors.

For AVS, the Intra prediction mode has reduced complexity compared to HEVC and H.264/AVC. AVS adopts macroblock (MB)/block structure, where the MB size is 16×16 and block size is 8×8. The Intra prediction is applied to each 8×8 block using reconstructed neighboring samples as shown in FIG. 5. AVS Intra prediction supports 5 Intra prediction modes corresponding to vertical, horizontal, diagonal down-right, diagonal down-left and DC modes as shown in FIG. 5. A filter with weighting corresponding to (¼, ½, ¼) is applied to the reconstructed neighboring samples before they are used to derive Intra predictors for the current block. For chroma components, only 4 Intra prediction modes corresponding to vertical, horizontal, DC and Plane modes are used. The Intra prediction for HEVC consists of a plurality of Intra prediction modes for the luma signal including five Intra prediction modes similar to the five Intra prediction modes for the AVS video coding standard, and a plurality of Intra prediction modes for the chroma signal including four Intra prediction modes similar to the four Intra prediction modes for the AVS video coding standard. While HEVC and AVS shares some similar Intra prediction modes, some detailed processing may not be the same. Similar to HEVC, the reconstructed neighboring blocks above the top block boundary is extended to the right block, and also the reconstructed neighboring blocks adjacent to the left block boundary is extended to the below block as shown in FIG. 5.

For Intra prediction, the reconstructed neighboring samples may not be available. This may occur in any video coding standard. A technique often used to deal with unavailable reference samples is data padding, where existing reconstructed samples or pre-defined values may be used to pad for the unavailable samples.

As discussed above, while both HEVC and AVS use Intra prediction, the two Intra prediction schemes are slightly different. A straightforward implementation to support dual-standard Intra prediction would use two separate Intra prediction modules. It is desirable to develop chip area-efficient or high performance multi-standard Intra prediction decoder.

### BRIEF SUMMARY OF THE INVENTION

An apparatus for multi-standard Intra prediction decoding in a video decoder for decoding two video streams coded in two different video coding standards is disclosed. The apparatus comprises a first Intra prediction decoder to decode a first bitstream comprising one or more first Intra prediction coded blocks, and a second Intra prediction decoder to decode a second bitstream comprising one or more second Intra prediction coded blocks. The first Intra prediction coded blocks are coded according to a first video coding standard and the second Intra prediction coded blocks are coded according to a second video coding standard. The first Intra prediction decoder and the second Intra prediction decoder are arranged to perform Intra prediction decoding on the two video streams simultaneously by decoding the two video streams in an interleaved manner at a picture level, slice level, or largest coding unit (LCU)/macroblock (MB) level. Each of the first Intra prediction decoder and the second Intra prediction decoder comprises following respective including a respective reference data preparation unit, a respective neighboring sample padding unit, a respective pre-filter unit, a respective Intra prediction generation unit, and a respective reconstruction data combination unit. At least two corresponding modules for the two respective Intra prediction decoders utilize one common circuit at least partially.

The first and second video coding standards may correspond to AVS video coding standard and HEVC (High Efficiency Video Coding) video coding standard. The AVS video coding standard applies Intra prediction on each 8×8 block within a 16×16 macroblock. On the other hand, the HEVC video coding standard applies Intra prediction for a plurality of prediction unit (PU) sizes including 8×8 and each PU is partitioned from a coding unit (CU) within one LCU including 16×16. The Intra prediction for AVS consists of five Intra prediction modes corresponding to DC, horizontal, vertical, diagonal down-right and diagonal down-left modes for a luma signal and four Intra prediction modes corresponding to the DC, horizontal, vertical and planar modes for a chroma signal. The Intra prediction for HEVC consists of a plurality of Intra prediction modes for the luma signal including five Intra prediction modes similar to the five Intra prediction modes for the AVS video coding standard, and a plurality of Intra prediction modes for the chroma signal including four Intra prediction modes similar to the four Intra prediction modes for the AVS video coding standard.

In one embodiment, the first reference data preparation unit and the second reference data preparation unit utilize a common reference data preparation unit wholly or partially when the HEVC video coding standard uses 8×8 PU and 16×16 LCU. In another embodiment, the first Intra prediction generation unit and the second Intra prediction generation unit utilize a common Intra prediction generation unit wholly or partially when the HEVC video coding standard uses 8×8 PU and 16×16 LCU, and the respective selected Intra prediction mode corresponds to horizontal or vertical mode for both the AVS video coding standard and the HEVC video coding standard. In yet another embodiment, the first Intra prediction generation unit and the second Intra prediction generation unit utilize partial common Intra prediction generation unit when the HEVC video coding standard uses 8×8 PU and 16×16 LCU, and the respective selected Intra prediction mode corresponds to a diagonal mode for both the AVS video coding standard and the HEVC video coding standard.

In one embodiment, the first Intra prediction generation unit and the second Intra prediction generation unit utilize one or more common adders when the HEVC video coding standard uses 8×8 PU and 16×16 LCU, and the respective selected Intra prediction mode corresponds to A DC mode for the AVS video coding standard and a planar mode for the HEVC video coding standard. In another embodiment, the first pre-filter unit and a second pre-filter unit utilize one common pre-filter unit wholly or partially when the HEVC video coding standard uses 8×8 PU and 16×16 LCU, and a filter flag for the HEVC video coding standard is set to regular filtering. In yet another embodiment, the first Intra prediction decoder and the second Intra prediction decoder retrieve the respective neighboring reference samples for the respective Intra prediction from a common neighbor buffer using same data access setting when the HEVC video coding standard uses 8×8 PU and 16×16 LCU.

The first Intra prediction decoder and the second Intra prediction decoder may utilize a common neighbor buffer to store the respective neighboring reference samples for the respective Intra prediction. The respective Intra prediction reconstructed samples at a bottom row of one LCU or MB is stored in the common neighbor buffer for a following LCU or MB row to access for the respective Intra prediction.

A corresponding method of multi-standard Intra prediction decoding for a video decoder to decode two video streams coded in two different video coding standards is also disclosed.

An apparatus for multi-standard Intra prediction decoding in a video decoder for decoding two video streams coded in AVC and HEVC standards using one or more processing elements (PEs) is also disclosed. The apparatus also includes a predictor selection unit coupled to the PEs to provide respective Intra predictors to the PEs for Intra prediction decoding of respective video coding standards. The apparatus also includes a PE parameter selection unit coupled to the PEs to provide PE parameters required to configure the PEs for decoding one video stream coded in a respective video coding standard. In order to use the PEs efficiently, for block size and Intra prediction modes supported by the AVS video coding standard, both AVS video coding standard and the HEVC video coding standard share same PE configuration and same PE parameter selection to perform the Intra prediction decoding.

### BRIEF DESCRIPTION OF THE DRAWINGS

FIG. 1 illustrates an exemplary system block diagram for a video decoder to support the High Efficiency Video Coding (HEVC) video standard.

FIG. 2 illustrates a typical TV system with built-in audio/video decoder.

FIG. 3A illustrates an example of picture level source switching process, where the decoder source is switched between AVS and HEVC bitstreams.

FIG. 3B illustrates an example of slice level source switching process, where the decoder source is switched between AVS and HEVC bitstreams.

FIG. 4 illustrates the 33 Intra prediction directions, including 33 angular directional modes, Planar mode and DC mode according to the High Efficiency Video Coding (HEVC) video standard.

FIG. 5 illustrates the Intra prediction block size (8×8) and the five Intra prediction modes (vertical, horizontal, diagonal down-right, diagonal down-left and DC) for the luma component according to the AVS standard.

FIG. 6 illustrates an example of flowchart for an Intra prediction decoder with picture level, slice level or LCU/MB level switching to support both HEVC and AVS coding standards.

FIG. 7 illustrates an example of flowchart according to an embodiment of the present invention for an Intra prediction decoder with picture level, slice level or LCU/MB level switching to support both HEVC and AVS coding standards.

FIG. 8A illustrates an exemplary block diagram for a multi-standard Intra prediction decoder incorporating an embodiment of the present invention.

FIG. 8B illustrates another embodiment similar to that in FIG. 8A. However, instead of two separate Intra prediction generators, the common Intra prediction generator is implemented in one processing module and the Intra prediction generator for other cases is implemented in another processing module.

FIG. 9 illustrates an example of multi-standard Intra prediction decoder using one or multiple PEs according to one embodiment of the present invention.

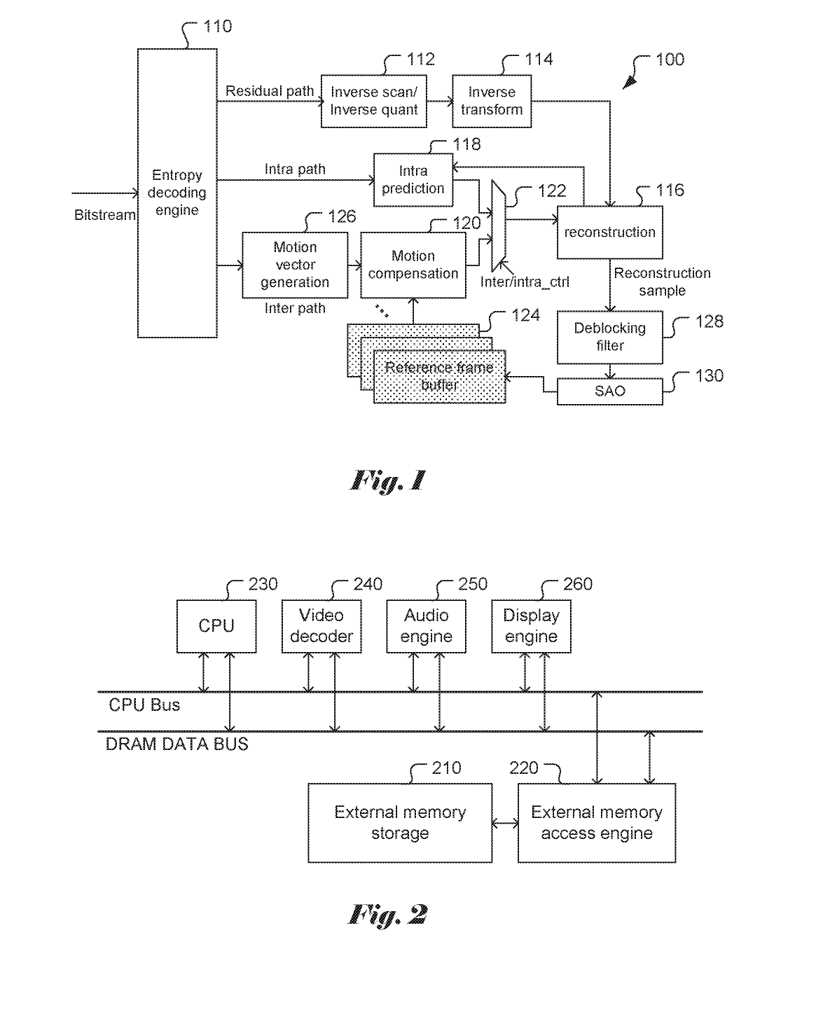

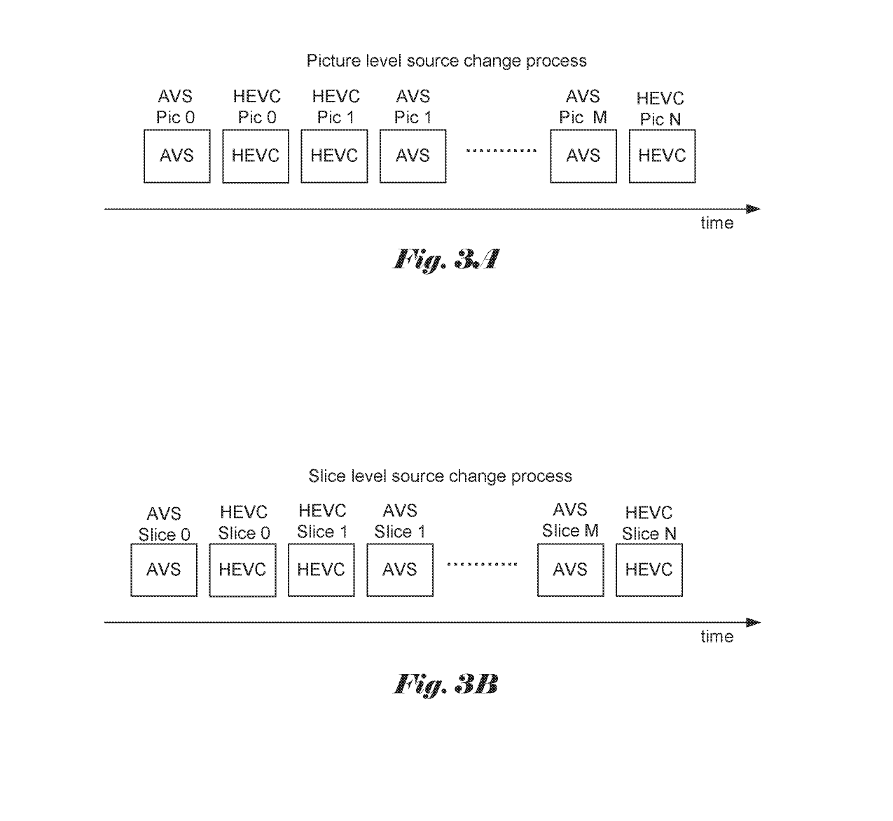

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

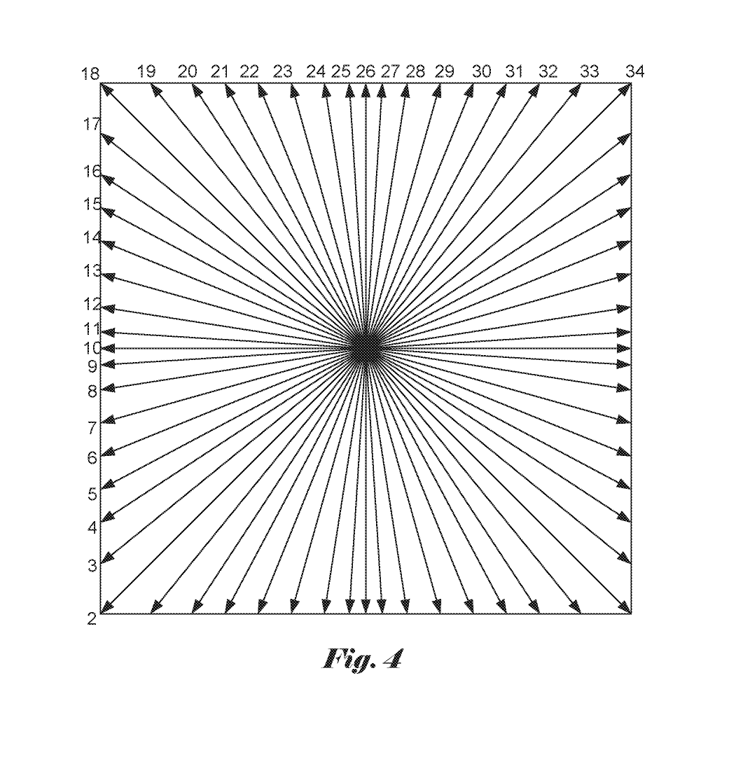

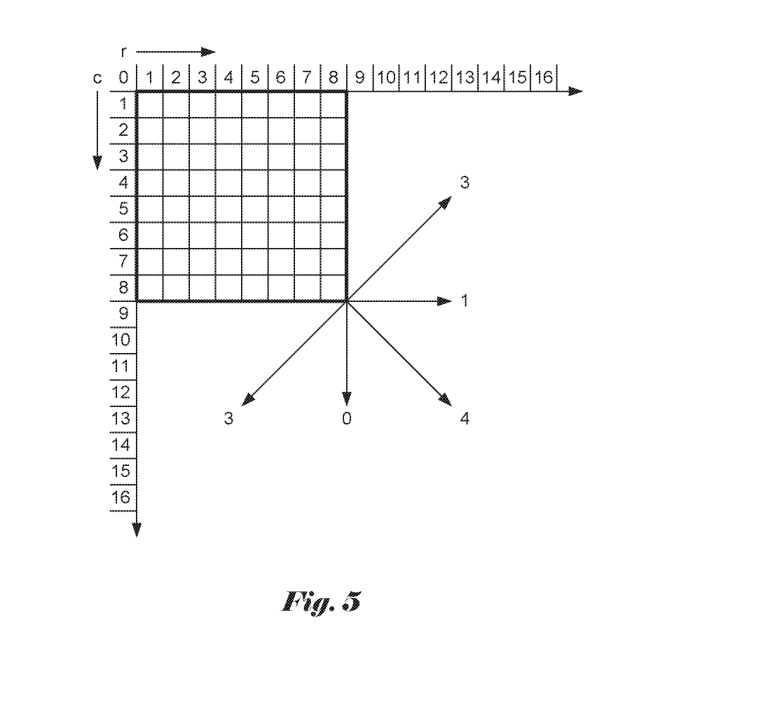

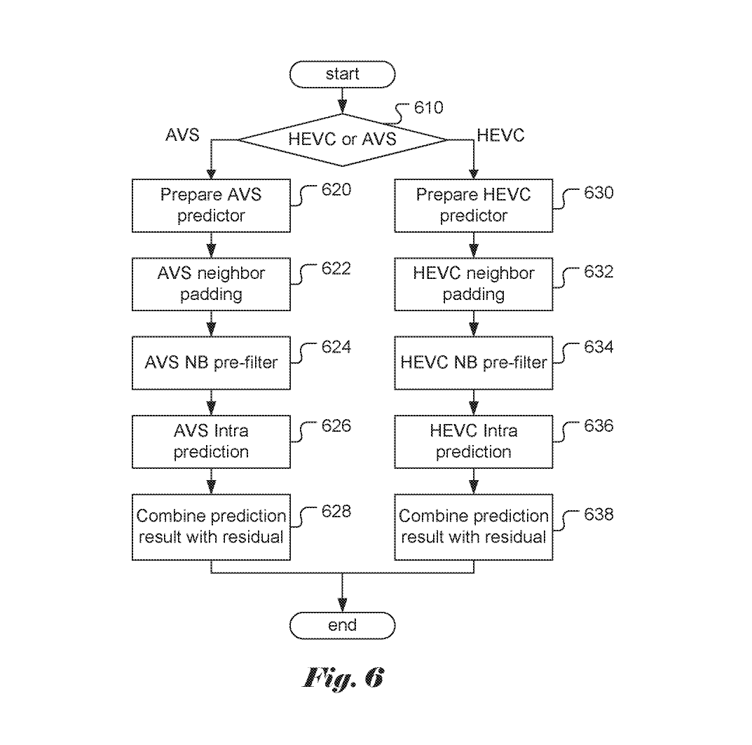

In order to support simultaneous multi-standard video decoding and display, the video decoding system may be configured to decode one coded video data and then switch to decode another coded video data. FIG. 3A illustrates an example of picture level source switching process, where the decoder source is switched between AVS and HEVC bitstreams. The decoder source switching process may also be applied at a slice level, where the decoder system may decode one AVS slice and then switch to decode one HEVC slice. FIG. 3B illustrates an example of slice level source switching process.

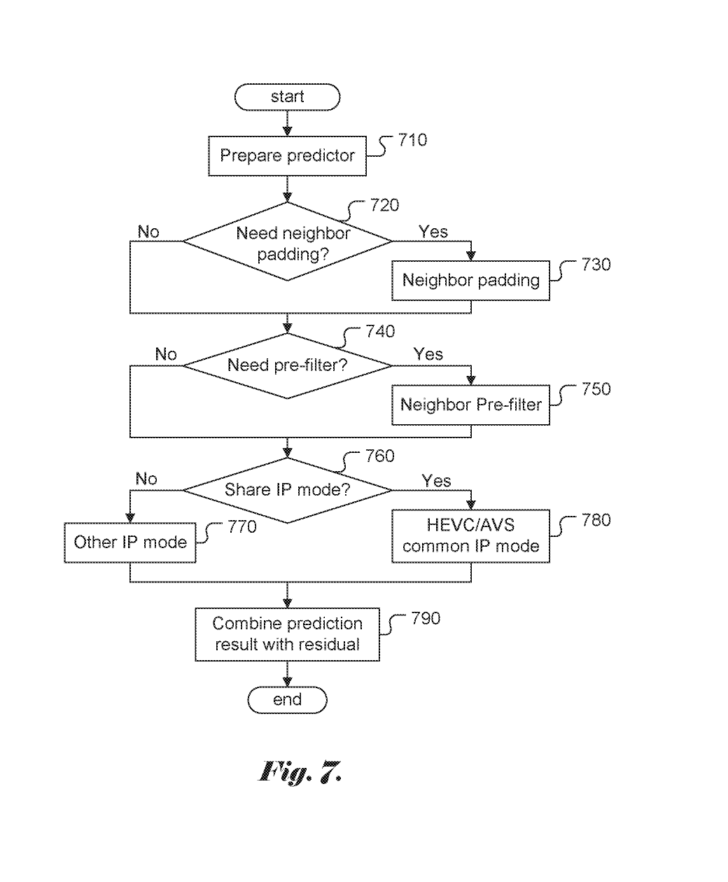

As mentioned before, a straightforward approach to Intra prediction decoder for multi-standard video decoder would require individual Intra prediction decoder for all intended video standards. This may noticeably increase the system cost. Therefore, it is desirable to develop area efficient (i.e., smaller silicon area) or high-performance Intra prediction decoder for multi-standard video decoder. FIG. 6 illustrates an example of flowchart for an Intra prediction decoder with picture level, slice level or LCU/MB level switching to support both HEVC and AVS coding standards. The multi-standard Intra prediction decoder determines whether the Intra prediction decoding is for HEVC or AVS as shown in step 610. If it is for AVS, steps 620 through 628 are performed. If it is for HEVC, steps 630 through 638 are performed. In step 620 and 630, reference samples for AVS Intra prediction and HEVC Intra prediction are identified and retrieved respectively. Also Intra prediction reconstructed data for the current blocks that may be used by other blocks may be stored in a reference data buffer. If there is any unavailable reference sample, the unavailable sample is padded with an existing or pre-define sample in step 622 or 632. For AVS or HEVC, neighbor predictor pre-filter is applied in step 624 or 634. The Intra predictors for the current block are derived in step 626 and 636 using the reference samples for the AVS and HEVC standards respectively. Reconstructed samples for Intra-coded block can be formed by combining the residual and the Intra predictors as shown in step 628 and 638 for the AVS and HEVC standards respectively.

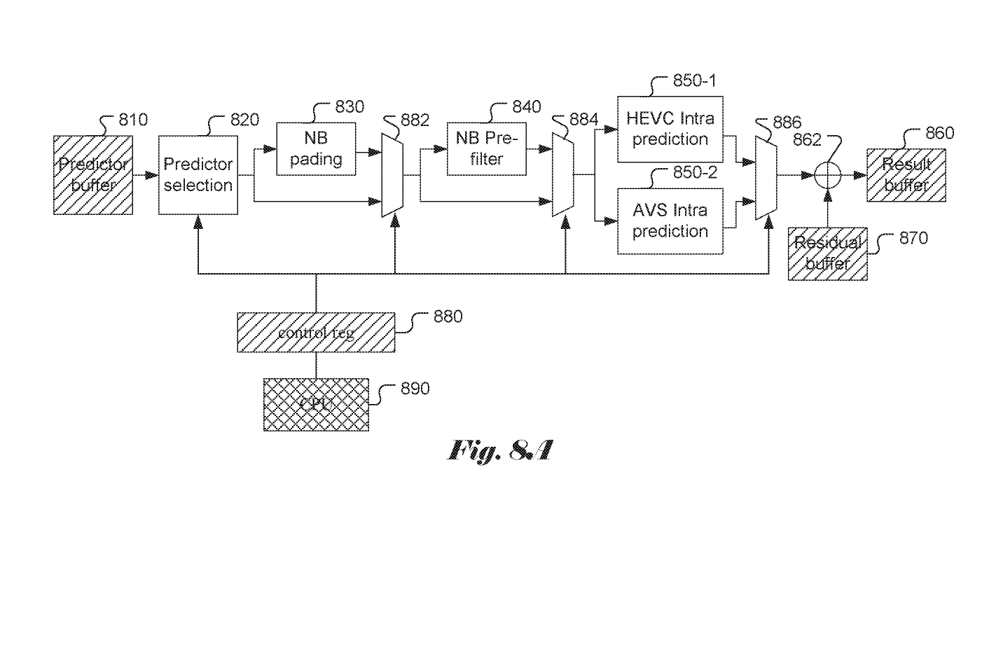

FIG. 7 illustrates an example of flowchart according to an embodiment of the present invention for an Intra prediction decoder with picture level, slice level or LCU/MB level switching to support both HEVC and AVS coding standard. Since Intra prediction decoding for AVS corresponds to a subset of the Intra prediction decoding process for the HEVC, AVS may use the HEVC processing modules or partially use some HEVC modules. Even though there may be some differences between corresponding AVS and HEVC Intra prediction decoding process, AVS may still use some operations used by HEVC. According to the embodiment in FIG. 7, the multi-standard Intra prediction decoder uses shared processing modules between AVS and HEVC standards whenever possible. Since both HEVC and AVS retrieve the same reconstructed neighboring samples for reference samples, the step of “Prepare predictor” (710) is the same for both HEVC and AVS. Therefore, the same processing module, either implemented in software of hardware, can be used for both HEVC and AVS. In step 720, it checks whether neighbor padding is needed. If it is needed (i.e., the “Yes” path from step 720), neighbor padding is performed in step 730. Otherwise (i.e, the “No” path from step 720), neighbor padding is bypassed. In step 740, it checks whether pre-filtering is needed. As mentioned before, pre-filtering is only needed for certain HEVC Intra prediction modes. If pre-filtering is needed (i.e., the “Yes” path from step 740), pre-filtering is performed in step 750. Otherwise (i.e., the “No” path from step 740), the pre-filtering is bypassed. As mentioned earlier, AVS only support the 16×16 MB and 8×8 blocks for Intra prediction. Also, AVS only supports 5 Intra prediction modes for the luma component and 4 Intra prediction modes for the chroma component. Therefore, the AVS Intra prediction modes are considered as a subset of the HEVC Intra prediction modes. Therefore, whether the Intra prediction mode is a shared Intra prediction mode is checked in step 760. If the result is “Yes”, step 780 is performed, where the Intra predictors associated with the common Intra prediction mode are generated for the current block. If the result is “No”, step 770 is performed, where the Intra predictors associated with other Intra prediction mode are generated for the current block. Finally, the current block is reconstructed by combining the Intra predictors generated and the residual as shown in step 790. Since both HEVC and AVS use the same Intra prediction reconstruction, the same processing module is used.

In FIG. 7, shared processing modules are used whenever possible. However, other embodiments of the present invention may also be used where only parts of the shared processing modules are used. For example, a multi-standard Intra prediction decoder may use only shared processing modules in step 710 and step 790, and use separate processing modules for remaining processing steps.

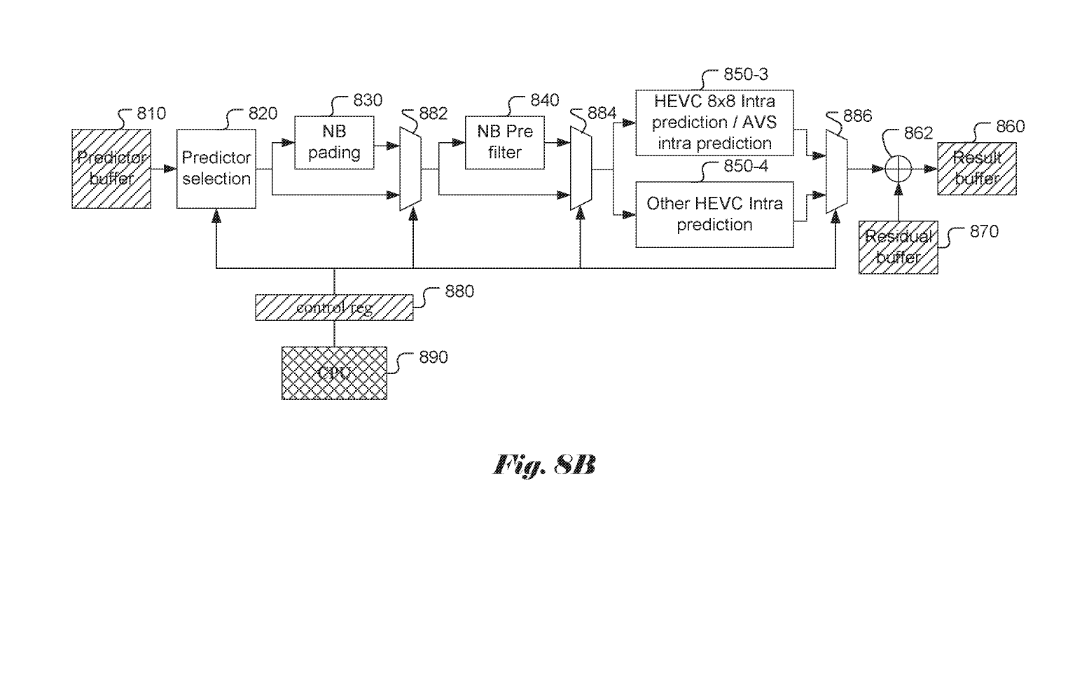

FIG. 8A illustrates an exemplary block diagram for a multi-standard Intra prediction decoder incorporating an embodiment of the present invention. The reconstructed samples to be used to derive Intra predictors are stored in predictor buffer 810. The reconstructed samples to generate the Intra predictors are determined by the predictor selection 820 according to predictor unit (PU) size, Intra prediction mode and block location. The selected Intra prediction mode and the video coding standard (i.e., HEVC or AVS) are provided from control_reg 880, which may in turn receive the information from CPU 890. The control_reg 880 is responsible for determining whether neighbor padding is required according to the PU size, Intra prediction mode, block location and predictor availability. If the padding is needed, selector 882 selects the data path from neighbor padding 830. Otherwise, neighbor padding 830 is bypassed. If neighbor pre-filtering is required, selector 884 selects data path from neighbor pre-filtering 840. Otherwise, neighbor pre-filtering 840 is bypassed. Whether neighbor pre-filtering is needed depends on the PU size, Intra prediction mode and block location. According to the video standard for the current block, either HEVC Intra predictors 850-1 or AVS Intra predictors 850-2 are generated. Selector 886 selects the corresponding Intra predictors for Intra prediction reconstruction. The Intra predictors from either block 850-1 or 850-2 are combined with residual from residual buffer 870 using adder 862. The reconstructed samples are then stored in result buffer 860 for further processing. In FIG. 8A illustrates the required processing, control and memory/buffer for multi-standard Intra prediction decoding. Some parts or modules in FIG. 8A may be considered as external to the multi-standard Intra prediction decoding core. For example, the predictor buffer (i.e., 810) may be part of system storage used to store reference pictures for decoding. Therefore, the predictor buffer is not considered as part of the multi-standard Intra prediction decoding core. Similarly, one or more modules from result buffer 860, residual buffer 870, control register 880 and CPU 890 may be considered as external to the multi-standard Intra prediction decoding core.

FIG. 8B illustrates another embodiment similar to that in FIG. 8A. However, instead of two separate Intra prediction generators, the common Intra prediction generator is implemented in one processing module (850-3) and the Intra prediction generator for other cases is implemented in another processing module (850-4). As mentioned before, the common Intra prediction corresponds to 8×8 block in the horizontal, vertical, diagonal down-left, diagonal down-right and DC mode for the luma component and DC, vertical, horizontal and plane for the chroma component. The implementation according to FIG. 8B is even more efficient than that in FIG. 8A since the common Intra prediction portion does not need to be repeated in both Intra prediction generators.

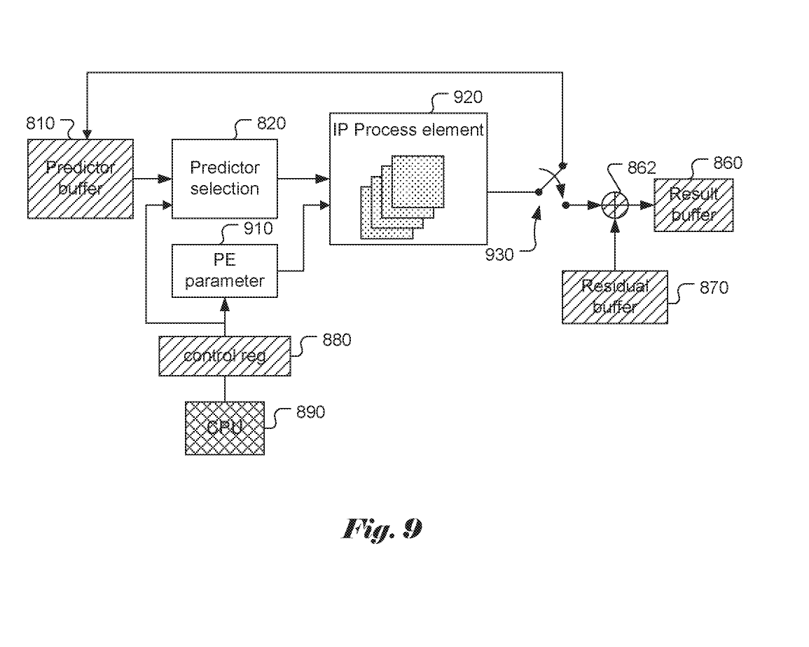

While FIG. 8A and FIG. 8B illustrate examples to used dedicated processing modules to implement required functions for Intra prediction decoding, the multi-standard Intra prediction may also be implemented using one or more process element (PE). The PE contains all operators, such as adder, multiplier, shifter, clamper, etc. needed for performing Intra prediction decoding. The Intra prediction mode, PU size and block location information are used to select predictor and PE parameter. FIG. 9 illustrates an example of multi-standard Intra prediction decoder using one or multiple PEs according to one embodiment of the present invention. Some modules are the same as these in FIGS. 8A and 8B. The same reference numbers are assigned to these modules. In FIG. 9, PE parameter block 910 stores PE parameters for configuring the PEs. The Intra prediction process elements 920 are used to implement padding, pre-filtering and Intra predictor generation functions. The PEs are configured or selected to perform the task of multi-standard Intra prediction decoding according to PU Intra prediction mode, PU size, PU location or any combination of them. Some of the reconstructed samples will be used as reference samples for Intra prediction of other blocks. Therefore, these samples to be used as reference samples for Intra prediction of other blocks will also be stored in the predictor buffer 810 under the control of switch 930.

As mentioned earlier, AVS Intra prediction can be considered as a subset of HEVC Intra prediction. Regarding reference sample selection for Intra prediction, AVS Intra prediction is applied to each 8×8 block within a 16×16 macroblock, which is equivalent to HEVC Intra prediction with PU size equal to 8×8 and LCU size equal to 16×16. Therefore, neighboring reference samples for these two cases are the same and a common processing module can be used to handle both cases.

Regarding Intra predictor derivation, the AVS horizontal and vertical modes are almost the same as HEVC 8×8 horizontal and vertical modes, except that HEVC applies additional Intra Gradient Filter (also called smoothing filter) to the generated Intra predictors. For 8×8 vertical mode, HEVC applies the following filtering process:

predSamples[x][y]=Clip1_{Y}(p[x][−1]+((p[−1][y]−p[−1][−1])>>1)). (1)

where predSamples[x][y] represents the Intra predictor located at (x,y), p[x][−1] represents neighboring reconstructed samples above the top block boundary, p[−1][y] represents neighboring reconstructed samples adjacent to the left block boundary, p[−1][−1] represents the upper-left neighboring reconstructed sample, and Clip1_{Y} ( ) corresponds to a clipping function. For 8×8 horizontal mode, HEVC applies the following filtering process:

predSamples[x][y]=Clip1_{Y}(p[−1][y]+((p[x][−1]−p[−1][−1])>>1)). (2)

Therefore, Intra predictor derivation for AVS horizontal and vertical modes can share the same Intra predictor generation for HEVC 8×8 horizontal and vertical modes with the Intra Gradient Filtering omitted. The above Intra Gradient Filtering process can be achieved by a dedicated device or by proper arrangement of process elements.

Regarding Intra predictor generation, the AVS diagonal down-left and diagonal down-right modes are similar to HEVC mode 18 for PU equal to 8×8. Therefore, some operators can be shared between AVS and HEVC. For PE based architecture, AVS can share HEVC PE and PE parameter selection to perform all Intra predictor derivation for all AVS Intra prediction modes.

AVS DC mode is different from the DC mode in other video coding standards such as HEVC. However, AVS DC mode can share some operations used in HEVC planar mode. The Intra predictor according to HEVC planar mode is shown as follows:

predSamples[x][y]=((nTbS−1−x)p[−1][y]+(x+1)*p[nTbS][−1]+(nTbS−1−y)*p[x][−1]+(y+1)*p[−1][nTbS]+nTbS)>>(Log 2(nTbS)+1). (3)

In equation (3), nTbS corresponds to the transform block size. On the other hand, AVS DC mode derives the Intra predictor according to the following pseudo codes:

If both up and left reference samples are available
pred[x, y]=(up′[x+1]+left′[y+1])>>1
else if only up reference sample is available
pred[x, y]=up′[x+1]
else if only left reference sample is available
pred[x, y]=left′[y+1]
else
pred[x, y]=128

In the above pseudo codes, pred[x, y] represents the Intra predictor located at (x,y), up′[x+1] represents the reference sample above the top block boundary, left′[y+1] and represent the reference sample adjacent to the left block boundary. As shown above, both AVS and HEVC use adder to combine Intra prediction data. Therefore, the same adder may be share by AVS and HEVC Intra prediction.

For AVS DC, diagonal down-left and diagonal down-right mode and for HEVC with filterFlag=1, a filtering process with filter coefficients (¼, ½, ¼) is applied to all neighboring reference samples before they are used to derive Intra predictors. Therefore, HEVC and AVS can share a same device to perform such filtering process.

HEVC also supports strong smooth filtering when the control flag, strong_intra_smoothing_enabled_flag is equal to 1 and PU size is 32×32. The strong filtering process is shown as follows:

1. pF[−1][−1]=p[−1][−1]

2. pF[−1][y]=((63−y)*p[−1][−1]+(y+1)*p[−1][63]+32)>>6, for y=0, . . . , 62

3. pF[−1][63]=p[−1][63]

4. pF[x][−1]=((63−x)*p[−1][−1]+(x+1)*p[63][−1]+32)>>6, for x=0, . . . , 62

5. pF[63][−1]=p[63][−1]

For reconstructing Intra coded samples, both AVS and HEVC can use the same adder to combine derived Intra predictors and the residual.

The Intra prediction process uses reconstructed neighboring samples above the top block boundary. Therefore, when a block is reconstructed, the bottom row of the reconstructed block will be used by the blocks below. Therefore, in some architecture, neighbor buffer is used to update up-side reconstruct result as predictor candidate. The reconstruct data at the bottom of a LCU/MB row are stored in a buffer, known as neighbor buffer, for the next LCU/MB row to access. AVS and HEVC can share same neighbor buffer when preparing predictor. In particular, AVS can use same neighbor buffer access mechanism as HEVC with LCU equal to 16×16.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

The parallel decoder system may also be implemented using program codes stored in a readable media. The software code may be configured using software formats such as Java, C++, XML (eXtensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention. The software code may be executed on different types of devices, such as laptop or desktop computers, hand held devices with processors or processing logic, and also possibly computer servers or other devices that utilize the invention. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. An apparatus for multi-standard Intra prediction decoding in a video decoder for decoding two video streams coded in two different video coding standards, the apparatus comprising:
a first Intra prediction decoder to decode a first bitstream comprising one or more first Intra prediction coded blocks, wherein said one or more first Intra prediction coded blocks are coded according to a first video coding standard;
a second Intra prediction decoder to decode a second bitstream comprising one or more second Intra prediction coded blocks, wherein said one or more second Intra prediction coded blocks are coded according to a second video coding standard, and
each of the first Intra prediction decoder and the second Intra prediction decoder comprises:
a respective reference data preparation unit to prepare respective neighboring reference samples for respective Intra prediction;
a respective neighboring sample padding unit to pad one or more respective neighboring reference samples if said one or more respective neighboring reference samples are unavailable for the respective Intra prediction;
a respective pre-filter unit to filter the respective neighboring reference samples for the respective Intra prediction;
a respective Intra prediction generation unit to generate respective Intra predictors from the respective neighboring reference samples for the respective Intra prediction according to a respective selected Intra prediction mode; and
a respective reconstruction data combination unit to generate respective Intra prediction reconstructed samples using the respective Intra predictors and respective residual; and
wherein two respective reference data preparation units, two respective neighboring sample padding unit, two respective pre-filter units, two respective Intra prediction generation unit, two respective reconstruction data combination units, or any combination thereof for the first Intra prediction decoder and the second Intra prediction decoder utilize one common circuit at least partially; and
wherein the first Intra prediction decoder and the second Intra prediction decoder are arranged to perform Intra prediction decoding on the two video streams simultaneously by decoding the two video streams in an interleaved manner at a picture level, slice level, or largest coding unit (LCU)/macroblock (MB) level.

2. The apparatus of claim 1, wherein the first video coding standard corresponds to AVS video coding standard and the second video coding standard corresponds to HEVC (High Efficiency Video Coding) video coding standard, wherein the AVS video coding standard applies Intra prediction on each 8×8 block within a 16×16 macroblock, the HEVC video coding standard applies Intra prediction for a plurality of prediction unit (PU) sizes including 8×8 and each PU is partitioned from a coding unit (CU) within one LCU including 16×16.

3. The apparatus of claim 2, wherein the Intra prediction for the AVS video coding standard consists of five Intra prediction modes corresponding to DC, horizontal, vertical, diagonal down-right and diagonal down-left modes for a luma signal and four Intra prediction modes corresponding to the DC, horizontal, vertical and planar modes for a chroma signal, and wherein the Intra prediction for the HEVC video coding standard consists of a plurality of Intra prediction modes for the luma signal including five Intra prediction modes similar to the five Intra prediction modes for the AVS video coding standard, and a plurality of Intra prediction modes for the chroma signal including four Intra prediction modes similar to the four Intra prediction modes for the AVS video coding standard.

4. The apparatus of claim 3, wherein a first reference data preparation unit for the first Intra prediction decoder and a second reference data preparation unit for the second Intra prediction decoder utilize a common reference data preparation unit wholly or partially when the HEVC video coding standard uses 8×8 PU and 16×16 LCU.

5. The apparatus of claim 3, wherein a first Intra prediction generation unit for the first Intra prediction decoder and a second Intra prediction generation unit for the second Intra prediction decoder utilize a common Intra prediction generation unit wholly or partially when the HEVC video coding standard uses 8×8 PU and 16×16 LCU, and the respective selected Intra prediction mode corresponds to horizontal or vertical mode for both the AVS video coding standard and the HEVC video coding standard.

6. The apparatus of claim 3, wherein a first Intra prediction generation unit for the first Intra prediction decoder and a second Intra prediction generation unit for the second Intra prediction decoder utilize partial common Intra prediction generation unit when the HEVC video coding standard uses 8×8 PU and 16×16 LCU, and the respective selected Intra prediction mode corresponds to a diagonal mode for both the AVS video coding standard and the HEVC video coding standard.

7. The apparatus of claim 3, wherein a first Intra prediction generation unit for the first Intra prediction decoder and a second Intra prediction generation unit for the second Intra prediction decoder utilize one or more common adders when the HEVC video coding standard uses 8×8 PU and 16×16 LCU, and the respective selected Intra prediction mode corresponds to DC mode for the AVS video coding standard and a planar mode for the HEVC video coding standard.

8. The apparatus of claim 3, wherein a first pre-filter unit and a second pre-filter unit utilize one common pre-filter unit wholly or partially when the HEVC video coding standard uses 8×8 PU and 16×16 LCU, and a filter flag for the HEVC video coding standard is set to regular filtering.

9. The apparatus of claim 3, wherein the first Intra prediction decoder and the second Intra prediction decoder retrieve the respective neighboring reference samples for the respective Intra prediction from a common neighbor buffer using same data access setting when the HEVC video coding standard uses 8×8 PU and 16×16 LCU.

10. The apparatus of claim 1, wherein the first Intra prediction decoder and the second Intra prediction decoder utilize a common neighbor buffer to store the respective neighboring reference samples for the respective Intra prediction.

11. The apparatus of claim 10, wherein the respective Intra prediction reconstructed samples at a bottom row of one LCU or MB is stored in the common neighbor buffer for a following LCU or MB row to access for the respective Intra prediction.

12. A method of multi-standard Intra prediction decoding for a video decoder to decode two video streams coded in two different video coding standards, the method comprising:
receiving a first bitstream comprising one or more first Intra prediction coded blocks according to a first video coding standard and a second bitstream comprising one or more second Intra prediction coded blocks according to a second video coding standard; and
decoding the two video streams simultaneously using a first Intra prediction decoder and a second Intra prediction decoder by switching between the first Intra prediction decoder and the second Intra prediction decoder in an interleaved manner at a picture level, slice level, or largest coding unit (LCU)/macroblock (MB) level; and
wherein the first Intra prediction decoder and the second Intra prediction decoder utilize one or more common operations selected from a group of Intra-prediction related operations comprising preparing respective neighboring reference samples, padding one or more respective neighboring reference samples, pre-filtering the respective neighboring reference samples, generating respective Intra predictors from the respective neighboring reference samples for the respective Intra prediction according to a respective selected Intra prediction mode, and generating respective Intra prediction reconstructed samples using the respective Intra predictors and respective residual.

13. The method of claim 12, wherein the first video coding standard corresponds to AVS video coding standard and the second video coding standard corresponds to HEVC (High Efficiency Video Coding) video coding standard, wherein the AVS video coding standard applies Intra prediction on each 8×8 block within a 16×16 macroblock, the HEVC video coding standard applies Intra prediction for a plurality of prediction unit (PU) sizes including 8×8 and each PU is partitioned from a coding unit (CU) within one LCU including 16×16.

14. The method of claim 13, wherein the Intra prediction for the AVS video coding standard consists of five Intra prediction modes corresponding to DC, horizontal, vertical, diagonal down-right and diagonal down-left modes for a luma signal and four Intra prediction modes corresponding to the DC, horizontal, vertical and planar modes for a chroma signal, and wherein the Intra prediction for the HEVC video coding standard consists of a plurality of Intra prediction modes for the luma signal including five Intra prediction modes similar to the five Intra prediction modes for the AVS video coding standard, and a plurality of Intra prediction modes for the chroma signal including four Intra prediction modes similar to the four Intra prediction modes for the AVS video coding standard.

15. The method of claim 13, wherein said generating respective Intra predictors from the respective neighboring reference samples for the respective Intra prediction according to a respective selected Intra prediction mode is implemented using a first processing module and a second processing module, wherein the first processing module generates the respective Intra predictors for common Intra prediction modes between the AVS video coding standard and the HEVC video coding standard, and the second processing module generates the respective Intra predictors for additional Intra prediction modes specific to the HEVC video coding standard.

16. The method of claim 12, wherein said padding one or more respective neighboring reference samples is performed if said one or more respective neighboring reference samples are unavailable.

17. The method of claim 12, wherein said pre-filtering the respective neighboring reference samples is performed according to a filter control flag.

18. An apparatus for multi-standard Intra prediction decoding in a video decoder for decoding two video streams coded in two different video coding standards, the apparatus comprising:
one or more processing elements (PEs), to perform Intra prediction decoding on the two video streams, wherein said one or more processing elements comprise operators configurable to decode the two video streams simultaneously by decoding the two video streams in an interleaved manner at a picture level, slice level, or largest coding unit (LCU)/macroblock (MB) level, and wherein the two video streams are coded in the two different video coding standards;
a predictor selection unit coupled to said one or more processing elements to provide respective Intra predictors to said one or more processing elements for Intra prediction decoding of respective video coding standards;
a PE parameter selection unit coupled to said one or more processing elements to provide PE parameters required to configure the PEs for decoding one video stream coded in a respective video coding standard; and
wherein the two different video coding standards correspond to AVS video coding standard and HEVC (High Efficiency Video Coding) video coding standard, wherein the AVS video coding standard supports a subset of block size supported by the HEVC video coding standard, and the AVS video coding standard supports a subset of Intra prediction modes supported by the HEVC video coding standard; and
wherein, for block size and Intra prediction modes supported by the AVS video coding standard, both AVS video coding standard and the HEVC video coding standard share same PE configuration and same PE parameter selection to perform the Intra prediction decoding.

19. The apparatus of claim 18, wherein the HEVC video coding standard applies the Intra prediction decoding to each prediction unit (PU), and wherein PU partition mode, PU size, PU location or any combination therefore is used to select one or more processing elements (PEs) and PE parameter for the Intra prediction decoding.

20. The apparatus of claim 18, wherein the AVS video coding standard only allows block size to be 8×8 and macroblock size to be 16×16, and wherein the AVS video coding standard only allows DC, horizontal, vertical, diagonal down-right and diagonal down-left modes for luma component, and allows DC, horizontal, vertical, and planar modes for chroma component.

21. The apparatus of claim 18, wherein said one or more processing elements (PEs) are further configured to perform pre-filtering on neighboring reference samples from one or more neighboring reconstructed blocks to generate Intra predictors for a current block.
